(19) United States
(12) Patent Application Publication
(10) Pub. No.: US 2003/0108312 A1
(43) Pub. Date: Jun. 12, 2003

(54) Fiber optical devices with high power handling capability

(76) Inventors: Yonglin Huang, Milpitas, CA (US); Kevin Zhang, Santa Clara, CA (US); Ping Xie, San Jose, CA (US)

Correspondence Address: Paul A. Levy, Fish & Richardson P.C., 45 Rockefeller Plaza, Suite 2800, New York, NY, 10111, US

(21) Appl. No.: 10/042,935

(22) Filed: Jan. 9, 2002

Related U.S. Application Data
(60) Provisional application No. 60/260,990, filed on Jan. 10, 2001.

(51) Int. Cl. G02B 6/32; G02B 6/02; G02B 6/16

(52) U.S. Cl. 385/123; 385/33

(57) ABSTRACT

Various embodiments of methods and systems of using TEC (Thermal-Diffusion Expanded Core) optical fiber to increase the power handling capabilities of an optical device are disclosed. In one embodiment, an optical device includes a TEC optical fiber that includes a first core. The diameter of the first core is larger at the end of the TEC optical fiber than it is in the unexpanded portion of the TEC optical fiber. The optical device also includes a focusing lens configured to focus light into the end of the TEC optical fiber so that a light spot created by the focused light on a surface of the end of the TEC optical fiber has a light spot diameter that is larger than the diameter of the first core in the unexpanded portion of the TEC optical fiber.

### BACKGROUND OF THE INVENTION

1. Field of the Invention

This invention relates to optical systems and, more particularly, to the optical and electro-optical devices used in high power optical systems.

2. Description of the Related Art

Optical fibers are used to transmit light in an optical system. FIG. 1 shows front and side views of a typical optical fiber 5. Optical fiber 5 includes a cladding 14 and a core 12. The core 12 is the actual light conduit of the optical fiber. The core 12 and/or the cladding 14 are doped so that the cladding 14 has a different index of refraction than the core 12. The cladding reflects light back into the core, causing light to propagate through the core 12 for the length of the optical fiber. Generally, an optical fiber 5 is capable of handling high optical powers as long as light is simply propagating through the fiber. However, in places where fiber 5 is terminated, the termination point may be vulnerable to damage that arises due to high power optical signals.

Light entering or leaving a termination end of an optical fiber 5 is focused into the core 12. Accordingly, at the point where light enters or leaves the termination end of the fiber 5, the intensity of the light is related to the diameter of the core 12. The smaller the core diameter, the smaller the diameter of the light spot formed on the end of the fiber and the greater the intensity of the light entering or leaving the termination end of the optical fiber.

In high power (e.g., around 1 Watt and higher) systems using single mode fiber (which typically has a relatively small core diameter), the intensity of light entering or leaving the termination end of an optical fiber may be significant. If any contaminants or irregularities are present at the termination end of the fiber, they may act as focusing lenses, creating localized spots of even higher intensities on the fiber end. The end of a fiber 5 may be coated with a dielectric coating to decrease insertion loss due to reflection and other unwanted effects that may occur as light enters or leaves the end of the optical fiber. At high intensities, light may burn the termination end of the fiber, damaging this coating. In extreme situations, burning may also damage the optical fiber itself. In such situations, the damage may increase the insertion loss and reflection of the fiber end. Additionally, the burning may damage the fiber so much that it is unable to operate properly and causes system disruption.

Typically, the core diameter is one of the points at which light is most focused in an optical system. Accordingly, termination ends of fibers are often the most vulnerable to being damaged in high power systems. It is desirable to be able to reduce the possibility that undesirable effects such as increased insertion loss will arise in high power optical systems. It is also desirable to be able to handle higher powers without a significantly increased potential of optical damage at the termination ends of optical fibers.

### SUMMARY

Various embodiments of methods and systems of using TEC (Thermal-Diffusion Expanded Core) optical fiber to increase the power handling capabilities of an optical device are disclosed. In one embodiment, an optical device includes a TEC optical fiber that includes a first core. The diameter of the first core at the end of the TEC optical fiber is larger than the diameter of the first core in an unexpanded portion of the TEC optical fiber. The optical device also includes a focusing lens configured to focus light into the end of the first optical fiber so that a light spot created by the focused light on a surface of the end of the TEC optical fiber has a light spot diameter that is larger than the diameter of the unexpanded portion of the first core.

In some embodiments, the TEC optical fiber may be part of an optical fiber pigtail that is permanently affixed in the optical device. The optical device may include an active component such as a laser diode configured to output the light to the focusing lens. The optical device may also (or alternatively) include a passive component configured to process the light and output the light to the focusing lens. An additional TEC optical fiber that includes a second core, where the diameter of the second core at the end of the additional TEC optical fiber is larger than the diameter of the second core in the unexpanded portion of the additional optical fiber, may input the light into the optical device.

One embodiment of a method of operating an optical device may involve providing light to a lens within the optical device and the lens focusing the light into the end of a TEC optical fiber having a first core and a first cladding. The diameter of the first core at the end of the TEC optical fiber is larger than the diameter of the first core in the unexpanded portion of the TEC optical fiber. A light spot created by focusing the light into the end of the TEC optical fiber has a light spot diameter that is larger than the diameter of the first core in the unexpanded portion of the TEC optical fiber.

### BRIEF DESCRIPTION OF THE DRAWINGS

A better understanding of the present invention can be obtained when the following detailed description is considered in conjunction with the following drawings, in which:

FIG. 1 shows front and side cross-sectional views of a typical optical fiber.

FIG. 2 shows front and side cross-sectional views of a thermal-diffusion expanded (TEC) fiber that may be included in one embodiment of an optical device.

FIG. 3 shows one embodiment of an optical device that includes TEC fiber.

FIG. 4 shows another embodiment of an optical device that includes TEC fiber.

FIG. 5 shows the size of a light spot relative to the size of the expanded and unexpanded portions of a TEC optical fiber in one embodiment of an optical device.

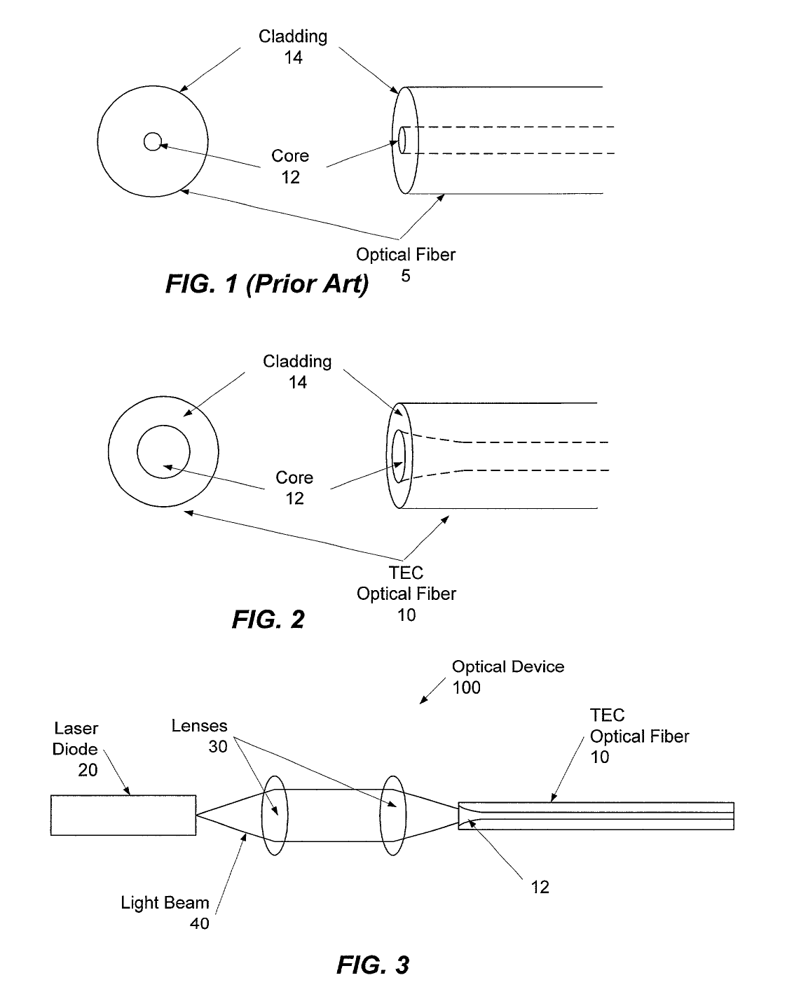

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include” and derivations thereof mean “including, but not limited to.” The term “connected” means “directly or indirectly connected,” and the term “coupled” means “directly or indirectly connected.”

### DETAILED DESCRIPTION OF EMBODIMENTS

FIG. 2 shows an example of a thermal-diffusion expanded core (TEC) optical fiber 10 that may be used in some embodiments. As shown, TEC optical fiber 10 begins at a termination end and continues to another end (not shown). The other end of the fiber may also have an expanded core in some embodiments. The optical fiber includes an inner core 12 surrounded by an outer cladding 14. TEC optical fiber 10 is formed by heating a portion of an optical fiber. The heating causes ion movement so that, in the heated portion, the area of the optical fiber that has core-type doping 12 becomes larger and the area that has cladding-type doping 14 becomes smaller. In the example shown in FIG. 2, (at least) one end of the optical fiber 10 has been thermally expanded so that core 12 is larger at the end of optical fiber 10 than it is in other portions of optical fiber 10. If optical fiber 5 is a single mode fiber used to transmit light with a wavelength between 980 nm to 1650 nm, the diameter of non-expanded portions of the core 12 may be between 6 and 11 μm. At the termination end of the fiber, the expanded portion of the core may have a diameter between 20 to 50 μm. The expanded portion of the fiber may be around 3 mm in length in such an embodiment. The termination end of the optical fiber 10 may be coated with a coating (e.g., a dielectric material) that reduces reflections at the termination end.

FIG. 3 shows one embodiment of an optical device 100. In this embodiment, optical device 100 includes a laser diode 20, one or more lenses 30, and a TEC optical fiber 10. As shown, laser diode 20 outputs light 40, which is collimated and focused by lenses 30 into the end of optical fiber 10. Optical device 100 may be packaged in an enclosure (not shown) in order to reduce the amount of contaminants to which the components of optical device 100 are exposed. In many embodiments, optical fiber 10 may be an optical fiber pigtail that is permanently attached to optical device 100 (e.g., so that optical device 100 may be attached and/or detached from other optical devices without having to realign optical fiber 10). In such an embodiment, additional optical fiber(s) may be coupled to the other end (not shown) of optical fiber pigtail 10 in order to integrate optical device 100 into an optical system. In some embodiments, the optical device may be configured to handle 1 Watt or more of power. In another embodiment, the optical device may be configured to handle between 3 and 5 Watts.

FIG. 5 shows one example of the relative size of the light spot formed on the termination end of optical fiber 10 by light beam 40. As shown in FIG. 5, the diameter of the light spot formed on the end of optical fiber 10 may be slightly smaller than the diameter of the expanded portion of core 12 at the termination end of optical fiber 10. In many embodiments, the coupling efficiency of the optical device may increase as the difference between the diameter of the light spot and the diameter of the expanded portion of the core 12 is decreased. Thus, in some embodiments, the diameter of the light spot may be about the same size as the diameter of the expanded portion of the core 12. The light spot diameter is larger than the diameter of the unexpanded portions of core 12.

Since the light spot is larger than it would be if the end of the fiber had not been thermally expanded, the intensity of the light is less than it would be if the light had been focused to have a smaller light spot diameter at the fiber end. The area of the core at the end of fiber 10 is π·r². If, for example, the unexpanded portion of the core has a diameter of 10 μm and the expanded portion of the core has a diameter of 30 μm, the focusing area at the termination end of the TEC optical fiber 10 may be 9 times (i.e., (π·30²)/(π·10²)) larger than the focusing area at the termination end of a non-expanded fiber. Accordingly, the optical power may be 9 times higher that that used with an unexpanded optical fiber while keeping the same (or a reduced) possibility that the light intensity will damage the termination end of the optical fiber 10. If the power of the light output from the light source is the same as that used with an unexpanded optical fiber, the larger core focusing area at the termination end of the TEC optical fiber may reduce the possibility that the light intensity will damage the termination end of optical fiber 10.

The configuration shown in FIG. 3 may be used in similar optical devices. Instead of a laser, other active optical components that output and/or receive light may be included, and optical fiber 10 may act as either an input or an output into optical device 100. For example, another embodiment of an optical device may include a receiver that receives light (e.g., via one or more collimating lenses) output from the termination end of a TEC optical fiber 10. Other exemplary active components that may be included in embodiments of optical device 100 include photosensors, transmitters, receivers, modulators, attenuators, switches, amplifier pumps, and semiconductor optical amplifiers. In some embodiments, both sending and receiving TEC optical fibers may be included in an optical device 100 so that the optical device may receive, process, and output one or more light beams.

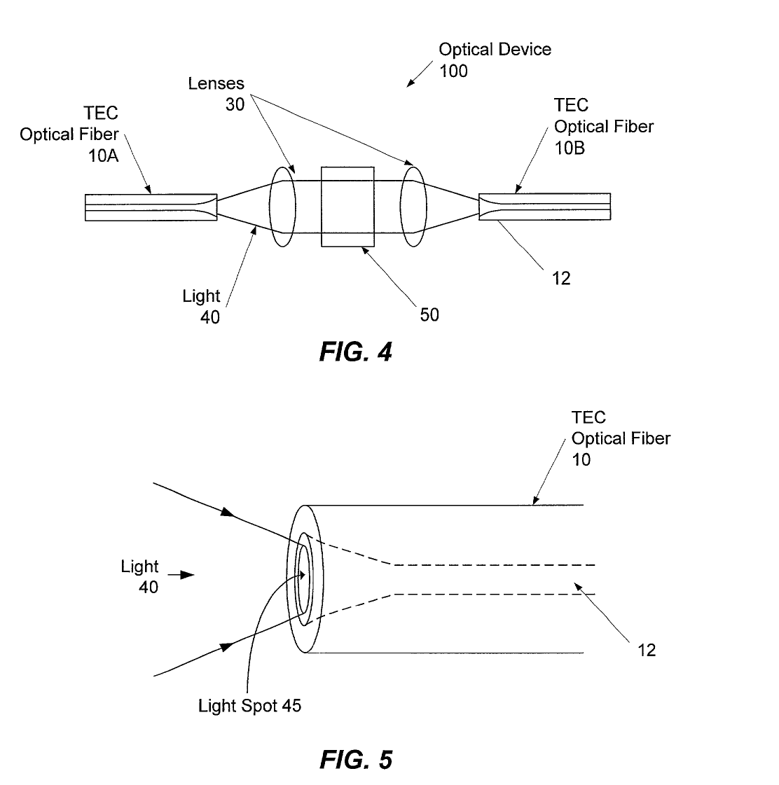

FIG. 4 shows another embodiment of an optical device 100. In this embodiment, a first optical fiber 10A inputs a light beam into optical device 100. A second optical fiber 10B receives a light beam output by optical device 100. A passive component 50 processes the input light beam to produce the output light beam. Two lenses 30 respectively collimate the input light beam and focus the output light beam. Exemplary passive optical components include lenses, glass crystals, gratings, mirrors, etc. such as those used in passive devices like collimators, isolators, couplers, multiplexers, filters, power splitters, etc. Note that in some embodiments, both active and passive components may be included (e.g., as shown in FIG. 3) in an optical device.

If both the input and output fibers are TEC fibers, as shown in FIG. 4, the light beam that is input to the output optical fiber 10B will have the same spot size as the light beam that is output from the input optical fiber 10A so long as lenses 30 are symmetrical lenses that are symmetrically arranged with respect to optical component 50 and the termination ends of optical fibers 10A and 10B. If the lenses 30 are not symmetrical or are not symmetrically arranged, the configuration and/or arrangement of the lenses may be such that the light beam input to optical fiber 10B has a spot size diameter that is larger than the diameter of the non-expanded portion of that fiber's core 12. Furthermore, if one of the optical fibers is not a TEC optical fiber, the lenses may be configured and/or arranged so that the light spot diameter at the termination end of the TEC optical fiber is larger than the diameter of the unexpanded portion of the TEC optical fiber's core.

While the embodiments shown in FIGS. 3-4 show optical devices that include one or two optical fibers, other embodiments may include multiple input and/or output optical fibers. For example, in some embodiments, optical device 100 may be a device such as a multiplexer, demultiplexer, or combiner that receives one or more inputs and produces one or more outputs. One or more of the optical fibers may be TEC optical fibers in such an embodiment. A component within the optical device is configured to process light so that the diameter of the light spot(s) on the termination end of the TEC optical fiber(s) are larger than the diameter(s) of the unexpanded portion of the core(s) of the TEC optical fiber(s).

Numerous variations and modifications will become apparent to those skilled in the art once the above disclosure is fully appreciated. It is intended that the following claims be interpreted to embrace all such variations and modifications.

What is claimed is:

1. An optical device comprising:
a TEC (Thermal-Diffusion Expanded Core) optical fiber including a first core, wherein a diameter of the first core at a first end of the TEC optical fiber is larger than the diameter of the first core in an unexpanded portion of the TEC optical fiber; and
a focusing lens configured to focus light into the first end of the TEC optical fiber such that a light spot created by the focused light on a surface of the first end of the TEC optical fiber has a light spot diameter that is larger than the diameter of the first core in the unexpanded portion of the TEC optical fiber.

2. The optical device of claim 1, wherein the TEC optical fiber is comprised in an optical fiber pigtail that is permanently affixed in the optical device.

3. The optical device of claim 1, further comprising an active component configured to output the light to the focusing lens.

4. The optical device of claim 3, wherein the active component comprises a laser diode.

5. The optical device of claim 1, further comprising a passive component configured to process the light and output the light to the focusing lens.

6. The optical device of claim 1, further comprising an additional TEC optical fiber that includes a second core, wherein a diameter of the second core at a first end of the additional TEC optical fiber is larger than the diameter of the second core in an unexpanded portion of the additional TEC optical fiber.

7. The optical device of claim 6, wherein the additional TEC optical fiber is configured to input the light into the optical device from the first end of the additional TEC optical fiber.

8. A method of operating an optical device comprising:
providing light to a lens within the optical device; and
the lens focusing the light into a first end of a TEC (Thermal-Diffusion Expanded Core) optical fiber having a first core and a first cladding, wherein a diameter of the first core at a first end of the TEC optical fiber is larger than the diameter of the first core in an unexpanded portion of the TEC optical fiber;
wherein a light spot created by said focusing on a surface of the first end of the TEC optical fiber has a light spot diameter that is larger than diameter of the first core in the unexpanded portion of the first core.

9. The method of claim 8, wherein the TEC optical fiber is comprised in an optical fiber pigtail that is permanently affixed in the optical device.

10. The method of claim 8, further comprising an active component outputting the light to the focusing lens.

11. The method of claim 10, wherein the active component comprises a laser diode.

12. The method of claim 8, further comprising a passive component processing the light and outputting the light to the lens.

13. The method of claim 8, wherein an additional TEC optical fiber includes a second core, wherein a diameter of the second core at a first end of the second TEC optical fiber is larger than the diameter of the second core in an unexpanded portion of the second optical fiber, wherein the method further comprises the additional TEC optical fiber outputting the light from the first end of the additional TEC optical fiber.
